(19) United States
(12) Patent Application Publication
(10) Pub. No.: US 2026/0152285 A1
(43) Pub. Date: Jun. 4, 2026

(54) ELECTRICAL PROPULSION SYSTEM FOR AN AERIAL VEHICLE, AERIAL VEHICLE INCLUDING SUCH AN ELECTRICAL PROPULSION SYSTEM

(71) Applicant: SAFRAN ELECTRICAL & POWER, Blagnac (FR)

(72) Inventor: Jérôme VALIRE, BLAGNAC (FR)

(73) Assignee: SAFRAN ELECTRICAL & POWER, Blagnac (FR)

(21) Appl. No.: 18/725,089

(22) PCT Filed: Dec. 21, 2022
(86) PCT No.: PCT/FR2022/052468

§ 371 Date: Jun. 27, 2024

(30) Foreign Application Priority Data
Dec. 27, 2021 (FR) 2114538

(51) Int. Cl. B64D 27/357; B64D 27/34; B64D 31/16; B64D 45/00; H02J 9/06

(52) U.S. Cl. CPC B64D 27/357; B64D 27/34; B64D 31/16; B64D 45/00; H02J 9/061; B64D 2045/0085; B64D 2221/00

(57) ABSTRACT

An electrical propulsion system for an aerial vehicle, including a plurality of electric motors, a plurality of power supply batteries for supplying power to the electric motors, and an electrical power distribution network connecting the power supply batteries to the electric motors. The electrical propulsion system can further include a backup battery configured to be connected to the electric motors by the electrical power distribution network. The electrical propulsion system can be configured to supply power to the electric motors according to at least two different power supply modes: a normal power supply mode, in which the backup battery does not supply power to any of the electric motors, and a backup power supply mode, in which the backup battery supplies power to at least one electric motor.

### TECHNICAL FIELD

The present invention belongs to the field of aerial vehicles with electric or hybrid propulsion, and more particularly relates to an electrical propulsion system for such aerial vehicles.

### PRIOR ART

These days, there is an increasing number of aerial vehicles fitted with electrical propulsion systems. This is particularly the case of unmanned aerial vehicles (UAVs) such as drones, or aerial vehicles carrying passengers, for example for urban mobility (air taxis, etc.).

An electrical propulsion system for an aerial vehicle uses multiple electric motors for takeoff, flight and landing of the aerial vehicle. The electric motors are powered by power supply batteries which provide the reserve of electrical power necessary for the duration of the mission of the aerial vehicle.

FIG. 1 schematically shows an example of an electrical propulsion system 10 according to the prior art.

As shown in FIG. 1, the electrical propulsion system 10 comprises several electric motors 11 supplied with power by several power supply batteries 12. The electric motors 11 are connected to the power supply batteries by an electrical power distribution network. In the example shown in FIG. 1, each power supply battery 12 supplies power in principle to two electric motors, and the electrical power distribution network incorporates reconfiguration mechanisms allowing, in the event of failure of a power supply battery (for example in the event of insufficient charge), to connect the electric motors which were powered by the faulty power supply battery to other non-faulty power supply batteries. Such reconfiguration mechanisms therefore make it possible to retain control of the aerial vehicle in the event of failure of a power supply battery, in particular to enable an emergency landing to be carried out in complete safety.

However, known architectures of electrical propulsion systems for aerial vehicles, such as the architecture shown in FIG. 1, require full knowledge of the electrical power available in each power supply battery to guarantee a mission in complete safety. Indeed, it must be possible to estimate the electrical power available in each power supply battery with sufficient accuracy to be able to reliably inform a user of the aerial vehicle as to how much of a range said aerial vehicle has left, so that the user can plan the mission for the aerial vehicle and know when it will have to make a landing.

In practice, it is difficult to ascertain the electrical power available in a power supply battery because this depends on many parameters, including the surroundings (temperature, humidity, etc.) and the history of use of each power supply battery. In addition, estimating the electrical power available in a power supply battery tends to become less accurate as the level of charge of this power supply battery falls. In other words, the less electrical power there is available in a power supply battery, the more difficult it is to have an accurate estimate of how much electrical power is available.

In practice, due to this uncertainty in the estimation of the electrical power available in each power supply battery, it is necessary to define and maintain a significant margin of electrical power in an attempt to ensure that, despite the degree of uncertainty in terms of estimation, there is sufficient electrical power available to carry out an emergency landing procedure. This margin is all the greater because in the event of failure of a power supply battery, a smaller number of power supply batteries has to power all the electric motors. The need to ensure a large margin also means increasing the weight on board the aerial vehicle.

### SUMMARY OF THE INVENTION

The present disclosure aims to overcome all or some of the limitations of the solutions found in the prior art, in particular those set out above, by proposing a solution making it possible in particular to reduce the margin of electrical power necessary and to ensure that in the event of failure of a power supply battery, the remaining electrical power is sufficient to carry out emergency maneuvers and in particular an emergency landing.

To this end, and according to a first aspect, it is proposed an electrical propulsion system for an aerial vehicle, comprising a plurality of electric motors, a plurality of power supply batteries for supplying power to said electric motors, and an electrical power distribution network connecting said power supply batteries to the electric motors. Said electrical propulsion system further comprises an additional power supply battery, referred to as a backup battery, adapted to be connected to the electric motors by the electrical power distribution network, and said electrical propulsion system is configured to supply power to the electric motors according to at least two different power supply modes:
a power supply mode referred to as a normal power supply mode, wherein the backup battery does not supply power to any of the electric motors, said electric motors being supplied with power by the power supply batteries,
a power supply mode referred to as a backup power supply mode, wherein the backup battery supplies power to at least one electric motor.

Thus, the electrical propulsion system is configured to supply power to the electric motors according to at least two different power supply modes, namely a normal propulsion mode used by default during takeoff, flight and landing phases, and a backup power supply mode used when at least one power supply battery is faulty (power supply battery malfunction or low charge level).

In addition, the electrical propulsion system according to the present disclosure incorporates an additional power supply battery, referred to as a backup battery, which is not used in the normal power supply mode, and which is used only in backup power supply mode, to take over from a faulty power supply battery.

Thus, in the event of failure of a power supply battery, it may be replaced by the backup battery. Since the backup battery is not used in the normal power supply mode, its charge level is in principle at a maximum when the electrical propulsion system switches to the backup power supply mode, such that the electrical power that it contains is known with a good degree of accuracy. By dimensioning the backup battery such that it is able to power the electric motors for a predetermined duration making it possible to carry out at least one emergency landing, the margin of electrical power on board the aerial vehicle may be significantly reduced compared to prior art solutions. To be specific, in prior art solutions, it is necessary to provide a margin for each power supply battery, due to the fact that each power supply battery may be used to compensate for a failure of another power supply battery, and at a time when the charge level, potentially low, does not make it possible to accurately estimate the electrical power available in each power supply battery. According to the present disclosure, the backup battery can supply power to all the electric motors and, when it begins to be used (i.e. at the start of the emergency situation created by the failure of a power supply battery), the backup battery always has a maximum charge level such that the electrical power available is known with accuracy.

In particular embodiments, the electrical propulsion system may also include one or more of the following optional features, alone or in all technically possible combinations.

In particular embodiments, the electrical propulsion system comprises a power supply battery failure detection module and a control module configured to implement the normal power supply mode when no power supply battery failure is detected and to implement the backup power supply mode when a failure of at least one power supply battery is detected.

In particular embodiments, the electrical power distribution network comprises first switching means adapted to connect/disconnect the backup battery to/from the electric motors, and the control module is configured to control the first switching means so as to:
in the normal power supply mode: disconnect the backup battery from the electric motors,
in the backup power supply mode: connect the backup battery to at least one electric motor.

In particular embodiments, the electrical power distribution network further comprises second switching means adapted to connect/disconnect the power supply batteries to/from the electric motors, and the control module is configured to control the second switching means so as to:
in the normal power supply mode: connect the power supply batteries to the electric motors,
in the backup power supply mode: disconnect each power supply battery detected as faulty by the failure detection module.

In particular embodiments, the backup battery has a nominal voltage lower than the respective nominal voltages of the power supply batteries.

In particular embodiments, the backup battery has a nominal voltage lower than the respective nominal voltages of the power supply batteries, and the electrical power distribution network is configured so that the backup battery is connected to the electric motors in the normal power supply mode and in the backup power supply mode, and so that the backup battery begins to supply power to an electric motor when the voltage across the terminals of the power supply battery which is supplying power to said electric motor becomes lower than the voltage across the terminals of the backup battery.

In particular embodiments, the backup battery is connected to each electric motor in parallel with at least one power supply battery.

In particular embodiments, the electrical propulsion system comprises a failure detection module configured to detect the switch from the normal power supply mode to the backup power supply mode.

In particular embodiments, the electrical power distribution network comprises switching means adapted to connect/disconnect the power supply batteries to/from the electric motors, and said electrical propulsion system comprises a control module configured to control the switching means so as to:
in the normal power supply mode: connect the power supply batteries to the electric motors,
in the backup power supply mode: disconnect each power supply battery detected as faulty by the failure detection module.

In particular embodiments, the failure detection module is configured to send a notification to a user of the aerial vehicle when the electric motors are being supplied with power in the backup power supply mode. The user may be a passenger in the aerial vehicle or may be on the ground, for example in the case of an aerial vehicle without passengers on board (UAV) and/or piloted remotely.

According to a second aspect, the present disclosure relates to an aerial vehicle comprising an electrical propulsion system according to any one of the embodiments of the present disclosure. The aerial vehicle may be exclusively with electric propulsion or with hybrid propulsion.

### PRESENTATION OF THE FIGURES

The invention will be understood more clearly on reading the following description, which is provided by way of non-limiting example, and with reference to the figures which show:

FIG. 1: already described a schematic depiction of an electrical propulsion system according to the prior art,

FIG. 2: a schematic depiction of a first example of an embodiment of an electrical propulsion system,

FIG. 3: a schematic depiction of a second example of an embodiment of an electrical propulsion system,

FIG. 4: a schematic depiction of a third example of an embodiment of an electrical propulsion system.

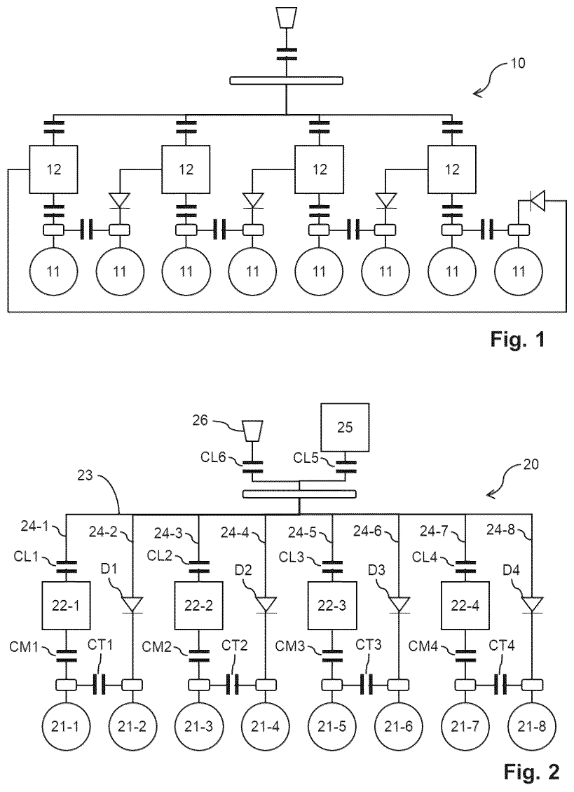

In these figures, references which are identical from one figure to the next designate identical or similar elements. For the sake of clarity, the elements shown are not to scale unless otherwise stated.

### DESCRIPTION OF THE EMBODIMENTS

As stated above, the present disclosure relates to an electrical propulsion system 20 for an aerial vehicle (not shown in the figures). The aerial vehicle may be exclusively with electric propulsion or with hybrid propulsion. Furthermore, the aerial vehicle may be an aerial vehicle without passengers, or an aerial vehicle capable of accommodating passengers.

FIG. 2 schematically shows an example of an embodiment of an electrical propulsion system 20 according to the present disclosure.

As shown in FIG. 2, the electrical propulsion system 20 firstly comprises a set of electric motors 21 making it possible to propel the aerial vehicle and to carry out the phases of takeoff, flight and landing of said aerial vehicle. Each of said electric motors 21 may be of any type suitable for the propulsion of an aerial vehicle.

In the non-limiting example shown in FIG. 2, the electrical propulsion system 20 comprises eight (8) electric motors 21. More generally, the electrical propulsion system 20 comprises at least two electric motors 21, and the total number of electric motors 21 may vary from one embodiment of the electrical propulsion system 20 to another. In the present disclosure, the electric motors are designated collectively (with no distinction between them) by the reference 21, while they are designated individually by the references 21-1 to 21-8, respectively.

The electrical propulsion system 20 also includes a set of power supply batteries 22 for supplying power to said electric motors 21. In the non-limiting example shown in FIG. 2, the electrical propulsion system 20 comprises four (4) power supply batteries 22. More generally, the electrical propulsion system 20 comprises at least two power supply batteries 22, and the total number of power supply batteries 22 may vary from one embodiment of the electrical propulsion system 20 to another. In the present disclosure, the power supply batteries are designated collectively (with no distinction between them) by the reference 22, while they are designated individually by the references 22-1 to 22-4, respectively.

The electrical propulsion system 20 also includes an electrical power distribution network connecting said power supply batteries 22 to the electric motors 21. The electrical power distribution network is made up of all of the elements making it possible to connect each power supply battery 22 to each electric motor 21 which is to be supplied with power by this power supply battery 22. For example, the electrical power distribution network is made up of a set of electrical lines and discrete components. In the non-limiting example shown in FIG. 2, the electrical power distribution network comprises in particular a main line 23, power supply lines 24-1 to 24-8 connecting the main line 23 to the various electric motors 21-1 to 21-8, and switching means (for example contactors) making it possible to reconfigure said electrical power distribution network, which will be discussed below.

As shown in FIG. 2, the electrical propulsion system 20 also includes an additional power supply battery, referred to as the backup battery 25, adapted to be connected to each of the electric motors 21 by the electrical power distribution network. Note that the propulsion system 20 may also, according to other examples of embodiments, include several backup batteries 25, for example for the purposes of redundancy of the backup battery 25. Where applicable, the backup batteries 25 are adapted to be connected to the electric motors 21, via the electrical power distribution network, such that each electric motor 21 may be powered by at least one of the backup batteries 25. However, in preferred embodiments of the electrical propulsion system 20, said electrical propulsion system 20 comprises a single backup battery 25, in order to limit the weight on board the aerial vehicle.

The remainder of the description focuses on the case where the electrical propulsion system 20 comprises a single backup battery 25, which therefore corresponds to preferred embodiments of the electrical propulsion system 20 making it possible to limit the margin of electrical power and the weight on board the aerial vehicle.

In the example shown in FIG. 2, the electrical power distribution network also includes a charging port 26, connected to the main line 23, intended to be connected to a source of electrical power (“Ground Power Unit”, or GPU) to charge the power supply batteries 22 and the backup battery 25, when the aerial vehicle is on the ground. The electrical power distribution network also includes switching means which include:
line contactors CL1 to CL4 allowing each power supply battery 22-1 to 22-4 to be connected to/disconnected from the main line 23,
a line contactor CL5 allowing the backup battery 25 to be connected to/disconnected from the main line 23,
a line contactor CL6 allowing the charging port 26 to be connected to/disconnected from the main line 23.

For example, during charging, the line contactors CL1 to CL6 are closed to connect the main line 23 to the power supply batteries 22-1 to 22-4, to the backup battery 25, and to the charging port 26. When charging is complete, the line contactors CL1 to CL6 are for example opened to disconnect the main line 23 from the power supply batteries 22-1 to 22-4, from the backup battery 25 and from the charging port 26.

In the example shown in FIG. 2, the switching means of the electrical power distribution network also include motor contactors CM1, CM2, CM3 and CM4 arranged on the power supply lines 24-1, 24-3, 24-5 and 24-7, respectively. When the motor contactors CM1, CM2, CM3 and CM4 are closed, the power supply batteries 22-1, 22-2, 22-3 and 22-4 are connected to the electric motors 21-1, 21-3, 21-5 and 21-7, respectively. In the example shown in FIG. 2, the switching means of the electrical power distribution network also include:
a transfer contactor CT1 arranged between power supply lines 24-1 and 24-2,
a transfer contactor CT2 arranged between power supply lines 24-3 and 24-4,
a transfer contactor CT3 arranged between power supply lines 24-5 and 24-6,
a transfer contactor CT4 arranged between power supply lines 24-7 and 24-8.

When the motor contactors CM1 to CM4 and the transfer contactors CT1 to CT4 are closed, the power supply batteries 22-1, 22-2, 22-3 and 22-4 are also connected to the electric motors 21-2, 21-4, 21-6 and 21-8, respectively.

In the example shown in FIG. 2, the electrical power distribution network also includes diodes D1, D2, D3 and D4 arranged on the power supply lines 24-2, 24-4, 24-6 and 24-8, respectively. The diodes D1 to D4 allow the passage of an electric current only from the main line 23 to the electric motors 21-2, 21-4, 21-6 and 21-8.

The electrical propulsion system 20 may also include a control module (not shown in the figures) which controls in particular the line contactors CL1 to CL6, the motor contactors CM1 to CM4 and the transfer contactors CT1 to CT4. The control module comprises for example one or more processors and one or more electronic memories (any type of computer-readable recording medium) in which a computer program product is stored, in the form of a set of instructions of program code to be executed to control the various switching means of the electrical power distribution network. Alternatively or in addition, the control module comprises one or more programmable logic circuits, of FPGA, PLD, etc. type, and/or specialized integrated circuits (ASIC), and/or discrete electronic components adapted to control the various switching means of the electrical power distribution network.

As stated above, the electrical propulsion system 20 is configured to supply power to the electric motors 21 according to at least two different power supply modes:
a power supply mode referred to as a normal power supply mode, in which the backup battery 25 does not supply power to any of the electric motors 21, the electric motors being supplied with power only by the power supply batteries 22,
a power supply mode referred to as a backup power supply mode, in which the backup battery 25 supplies power to at least one electric motor.

Thus, the backup battery 25 is not called upon in the normal power supply mode, which is used by default during the phases of takeoff, flight and landing of the aerial vehicle. However, the backup battery 25 is used in the backup power supply mode, to take over from one or more faulty power supply batteries 22 (power supply battery 22 malfunction or low charge level).

For example, in the normal power supply mode, motor contactors CM1 to CM4 and transfer contactors CT1 to CT4 are closed by the control module, while line contactors CL1 to CL6 are opened by the control module. Thus, the backup battery 25 is not connected to any of the electric motors 21-1 to 21-4. The power supply battery 22-1 powers the electric motors 21-1 and 21-2, the power supply battery 22-2 powers the electric motors 21-3 and 21-4, the power supply battery 22-3 powers the electric motors 21-5 and 21-6, and the power supply battery 22-4 powers the electric motors 21-7 and 21-8.

In the backup power supply mode, the control module may switch the line contactor CL5 to the closed state, such that the backup battery 25 becomes connected to all the electric motors 21-1 to 21-8, via the power supply lines 24-2, 24-4, 24-6 and 24-8, respectively, and the transfer contactors CT1 to CT4 in the closed state. The line contactor CL5 therefore corresponds to switching means making it possible to connect/disconnect the backup battery 25 to/from the electric motors 21.

In order to know when to switch from the normal power supply mode to the backup power supply mode, the electrical propulsion system 20 includes for example a failure detection module (not shown in the figures). The failure detection module includes for example a set of sensors making it possible to detect the failure of one of the power supply batteries 22, for example by measuring the voltages across the terminals of said power supply batteries 22. To be specific, a low charge level of a power supply battery 22 will cause a detectable drop in the voltage across its terminals, compared to a nominal voltage of said power supply battery 22. However, the failure detection module may implement any means making it possible to detect the failure of a power supply battery 22. Thus, when the failure detection module detects the failure of a power supply battery 22, the control module may trigger the switch from the normal power supply mode to the backup power supply mode. In preferred embodiments, the control module may also isolate the power supply battery detected as faulty by the failure detection module. For example, if the power supply battery 22-1 is detected as faulty, then the control module may open the motor contactor CM1 in order to disconnect the power supply battery 22-1 from the electric motors 21-1 and 21-2, which are then supplied with power by the backup battery 25 (the transfer contactor CT1 remaining in the closed state). The motor contactors CM1 to CM4 therefore correspond to switching means making it possible to connect/disconnect the power supply batteries 22 to/from the electric motors 21.

In the example shown in FIG. 2, in the backup power supply mode, the backup battery 25 is connected to all the electric motors 21, such that it can power all the electric motors 21, even those which are still connected to non-faulty power supply batteries 22. In preferred embodiments, the backup battery 25 has a nominal voltage lower than the respective nominal voltages of the power supply batteries 22. For example, the nominal voltage of the backup battery 25 may be between 600 volts (V) and 700 V and the nominal voltage of the power supply batteries 22 may be between 700 V and 800 V. Consequently, in the example of FIG. 2 and in the backup power supply mode, an electric motor 21 will only be supplied with power by the backup battery 25 if the voltage across the terminals of the electric motor 21 (supplied by a power supply battery 22) is lower than the voltage across the terminals of the backup battery 25. This will be the case for an electric motor 21 supplied with power by a faulty power supply battery 22, but will not generally be the case for the other electric motors 21 supplied with power by non-faulty power supply batteries 22. Consequently, in such a case, the backup battery 25, although connected to all the electric motors 21, essentially only supplies power to electric motors 21 powered by a faulty power supply battery 22. In addition, the non-faulty power supply batteries 22 do not discharge to the backup battery 25 owing to the presence of the diodes D1 to D4.

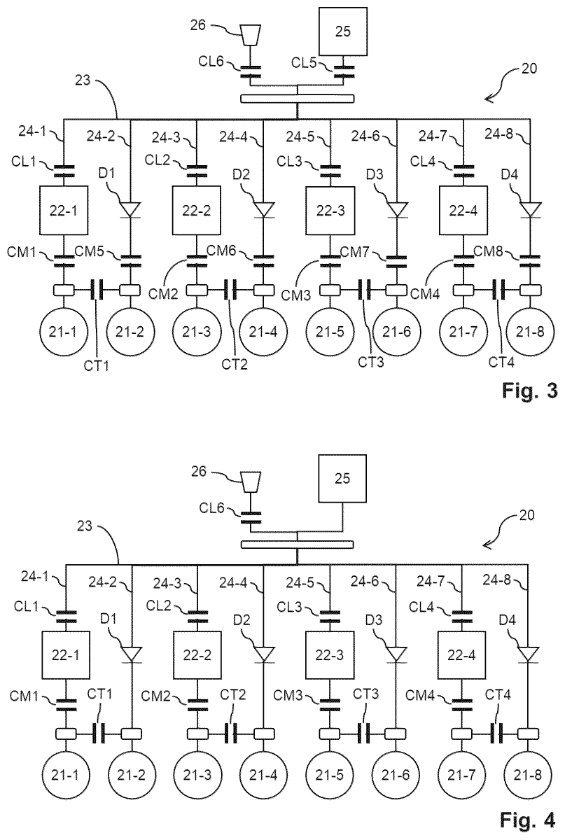

FIG. 3 schematically shows another example of an embodiment of an electrical propulsion system 20 according to the present disclosure. In addition to the elements already described with reference to FIG. 2, the electrical propulsion system 20 of FIG. 3 comprises motor contactors CM5, CM6, CM7 and CM8 arranged on the power supply lines 24-2, 24-4, 24-6 and 24-8, respectively.

In the example shown in FIG. 3, in the normal power supply mode, the motor contactors CM1 to CM4 and the transfer contactors CT1 to CT4 are closed by the control module, while the line contactors CL1 to CL6 and the motor contactors CM5 to CM8 are opened by the control module.

In the backup power supply mode, the control module switches the line contactor CL5 to the closed state. Preferably, out of the motor contactors CM5 to CM8, the control module switches to the closed state only the motor contactor which is connected to an electric motor 21 supplied with power by the faulty power supply battery 22. For example, if the power supply battery 22 detected as faulty is the power supply battery 22-1, then the control module only switches the motor contactor CM5 to the closed state. However, in other examples, there is nothing to prevent all the motor contactors CM5 to CM8 being switched to the closed state. The line contactor CL5 and the motor contactors CM5 to CM8 therefore correspond to switching means making it possible to connect/disconnect the backup battery 25 to/from the electric motors 21. As described above, the control module may, in particular embodiments, isolate the faulty power supply battery 22 by controlling the motor contactors CM1 to CM4 accordingly.

FIG. 4 schematically shows another example of an embodiment of an electrical propulsion system 20 according to the present disclosure. The electrical propulsion system 20 of FIG. 4 includes all of the elements described with reference to FIG. 2, with the exception of the line contactor CL5. Thus, in this embodiment, the backup battery 25 is always connected to the electric motors 21, whatever the power supply mode in question. However, in this embodiment, the backup battery 25 has a nominal voltage lower than the respective nominal voltages of the power supply batteries 22, such that the backup battery 25 does not discharge (and does not supply power to the electric motors 21) as long as the voltages across the terminals of the power supply batteries 22 are greater than the voltage across the terminals of the backup battery 25. However, the backup battery 25 begins to supply power to an electric motor 21 when the voltage across the terminals of the power supply battery 22 which powers this electric motor 21 becomes lower than the voltage across the terminals of the backup battery 25. For example, the nominal voltage of the backup battery 25 may be between 600 volts (V) and 700 V and the nominal voltage of the power supply batteries 22 may be between 700 V and 800 V. Thus, the backup battery 25 takes over from a faulty power supply battery 22 automatically, without having to change the state of the various switching means of the electrical power distribution network and without having to detect the failure of this power supply battery 22. Therefore, the intervention of a control module or of a failure detection module is not necessary to switch from the normal power supply mode to the backup power supply mode. However, the electrical propulsion system 20 may nevertheless comprise a failure detection module configured to detect the switch from the normal power supply mode to the backup power supply mode. If the failure detection module is further configured to detect which power supply battery 22 is faulty, then the control module can, in particular embodiments, isolate the faulty power supply battery 22 by controlling the motor contactors CM1 to CM4 accordingly.

In particular embodiments, when the electrical propulsion system 20 comprises a failure detection module, then this is preferably configured to send a notification to a user of the aerial vehicle, to inform them that the backup power supply mode is being used. To be specific, even though the use of the backup battery 25 makes it possible to have a more accurate estimate of the available electrical power, the user must be informed that failure of a power supply battery 22 has been detected in order to trigger, for example, an emergency landing procedure. The user is for example the pilot of the aerial vehicle, who may be a passenger in the aerial vehicle or may be on the ground, for example in the case of an aerial vehicle piloted remotely.

More generally, it should be noted that the modes of implementation and embodiments discussed above have been described by way of non-limiting examples, and that other variants are therefore possible.

In particular, the invention has been described with reference to particular examples of embodiments of the electrical propulsion system 20. Other variants may be envisaged, as long as they make it possible to have an electrical propulsion system 20 comprising a backup battery 25 which is not used in a normal power supply mode for powering the electric motors, such that its level of charge is a priori at a maximum and known with accuracy when it is used in a backup power supply mode.

1. An electrical propulsion system for an aerial vehicle, comprising:
a plurality of electric motors;
a plurality of power supply batteries for supplying power to the electric motors;
an electrical power distribution network connecting the power supply batteries to the electric motors; and
a backup battery configured to be connected to the electric motors by the electrical power distribution network,
wherein the electrical propulsion system is configured to supply power to the plurality of electric motors according to at least two different power supply modes:
a normal power supply mode in which the backup battery does not supply power to any of the plurality of electric motors the plurality electric motors being supplied with power by the power supply batteries; and
a backup power supply mode in which the backup battery supplies power to at least one of the plurality of electric motors,
wherein the backup battery has a nominal voltage lower than the respective nominal voltages of the plurality of power supply batteries, and
wherein the electrical power distribution network is configured such that the backup battery is connected to the plurality of electric motors in the normal power supply mode and in the backup power supply mode such that the backup battery begins to supply power to at least one of the plurality of electric motors when the voltage across the terminals of the plurality of power supply batteries which are supplying power to the plurality of electric motors becomes lower than the voltage across the terminals of the backup battery.

2. The electrical propulsion system according to claim 1, wherein the backup battery is connected to each electric motor in parallel with at least one of the plurality power supply batteries.

3. The electrical propulsion system according to claim 1, comprising a failure detection module configured to detect a switch from the normal power supply mode to the backup power supply mode.

4. The electrical propulsion system according to claim 3, wherein the electrical power distribution network comprises switching means adapted to connect/disconnect the plurality of power supply batteries to/from the plurality of electric motors, and wherein the electrical propulsion system comprises a control module configured to control the switching means so as to:
in the normal power supply mode, connect the plurality of power supply batteries to the plurality of electric motors;
in the backup power supply mode, disconnect from the plurality of electric motors each power supply battery of the plurality of power supply batteries detected as faulty by the failure detection module.

5. The electrical propulsion system according to claim 3, wherein the failure detection module is configured to send a notification to a user of the aerial vehicle when at least one of the plurality of electric motors are being supplied with power in the backup power supply mode.

6. An aerial vehicle comprising an electrical propulsion system according to any claim 1.
